(19) United States
(12) Patent Application Publication
(10) Pub. No.: US 2026/0237169 A1
(43) Pub. Date: Aug. 13, 2026

(54) ROTATIONALLY AUGMENTING THREE-DIMENSIONAL DATA TO TRAIN A MACHINE LEARNING MODEL

(71) Applicants: International Business Machines Corporation, Armonk, NY (US); Arizona Board of Regents on behalf of Arizona State University, Scottsdale, AZ (US)

(72) Inventors: Tiffany Jean Lee Callahan, San Jose, CA (US); Sara Capponi, San Francisco, CA (US); Björn Matthias Heyden, Phoenix, AZ (US)

(21) Appl. No.: 19/049,050

(22) Filed: Feb. 10, 2025

(51) Int. Cl. G06T 19/20; G06T 17/00

(52) U.S. Cl. CPC G06T 19/20; G06T 17/00; G06T 2210/56; G06T 2219/2016

(57) ABSTRACT

Examples described herein provide a computer-implemented method for training a machine learning model. The method includes generating a rotation matrix for a three-dimensional (3D) representation of an object based at least in part on a given rotation axis and rotation angle. The method further includes generating a rotated coordinate grid based at least in part on the rotation matrix and an original coordinate grid for the 3D representation. The method further includes training the machine learning model based at least in part on the original coordinate grid and the rotated coordinate grid for the 3D representation.

### STATEMENT REGARDING FEDERALLY SPONSORED RESEARCH OR DEVELOPMENT

This invention was made with government support under DBI-1548297 awarded by the National Science Foundation. The government has certain rights to this invention.

### BACKGROUND

The present disclosure relates to computing environments, and more specifically, to rotationally augmenting three-dimensional data to train a machine learning model.

Three-dimensional (3D) data refers to information that defines the structure, shape, and spatial attributes of objects or environments in 3D space, often used in fields such as computer graphics, simulation, and machine learning. Common 3D representations include: meshes, which define surfaces using vertices, edges, and faces; point clouds, which are sets of discrete points representing sampled positions on an object or scene without explicit connectivity; and voxels, which are grid-based volumetric elements that divide 3D space into uniform cubes, much like 3D pixels. Each representation has its strengths, for example, point clouds are efficient for sparse and raw spatial data, while voxels excel at representing solid volumes in a regular structure, though they can be memory-intensive. Together, these formats enable diverse applications, from 3D printing to virtual reality.

### SUMMARY

According to an embodiment, a method for rotationally augmenting 3D data to train a machine learning model is provided. The method includes generating a rotation matrix for a three-dimensional (3D) representation of an object based at least in part on a given rotation axis and rotation angle. The method further includes generating a rotated coordinate grid based at least in part on the rotation matrix and an original coordinate grid for the 3D representation. The method further includes training the machine learning model based at least in part on the original coordinate grid and the rotated coordinate grid for the 3D representation.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment having a 3D augmentation engine according to one or more embodiments described herein;

FIG. 2 illustrates a block diagram of components of a machine learning training and inference system according to one or more embodiments described herein;

FIG. 3 illustrates a flow diagram of a method for training a machine learning model according to one or more embodiments described herein;

FIG. 4A illustrates a given rotation axis and rotation angle and a rotation matrix according to one or more embodiments described herein;

FIG. 4B illustrates an original coordinate grid and a rotated coordinate grid according to one or more embodiments described herein;

FIG. 4C illustrates a table and an array according to one or more embodiments described herein;

FIG. 5A illustrates a given rotation axis and rotation angle and a rotation matrix according to one or more embodiments described herein;

FIG. 5B illustrates an original coordinate grid, an off-grid value, and a rotated coordinate grid with interpolation according to one or more embodiments described herein;

FIG. 5C illustrates a table and an array according to one or more embodiments described herein; and

FIG. 6A-6H illustrate 3D representations used to train a machine learning model according to one or more embodiments described herein.

### DETAILED DESCRIPTION

One or more embodiments described herein provide for rotationally augmenting 3D data to train a machine learning model.

In the realm of machine learning, the utilization of 3D molecular structure data plays a role in developing models that can generalize across various geometric transformations. Typically, 3D data, such as 3D molecular structures data, are represented in two primary forms: point clouds, which include Cartesian coordinates indicating the presence of an object in space, and voxel data, where each voxel represents a value within a coordinate grid inferred from its relative position in an array.

Building generalizable machine learning models using 3D data, such as 3D molecular structure data, requires the consideration of geometric transformations (e.g., rotations and translations). Invariance and equivariance are symmetric properties of functions which specify the behavior of data under geometric transformations. A machine learning model's prediction is “invariant” to a geometric transformation if the model's output does not change when the model's input is transformed. For example, the prediction of a molecule's energy does not change when the molecule is rotated. In contrast, a model's prediction is “equivariant” to a geometric transformation if the model's output changes in the same way as the model's input when transformed. For example, dipole moment predictions should rotate with an input molecule.

Mathematically, invariance can be shown to be a special case of equivariance, which means solutions for addressing equivariance can be adapted to also address invariance. Some existing approaches in machine learning address equivariance by: (1) using equivariant neural networks; (2) applying data transformation/abstraction; or (3) performing training data augmentation. Some existing models, like E(n)-graph neural networks, are equivariant to several types of geometric transformations, but can be computationally prohibitive to implement and may not be appropriate for all data types. Data transformations/abstractions can also address multiple types of geometric transformations but often result in some amount of information loss. Accordingly, the need for a robust approach to training machine learning models using 3D data transformations remains.

A more robust approach would enable users to combine strategies to best address the geometric transformations and symmetry properties relevant to their use case. For example, address translational and rotational equivariance by applying a translationally equivariant convolution neural network to rotationally augmented training data.

Rotational augmentation provides an additional benefit by increasing the size of training data, which addresses a significant limitation of building deep models or very large models, like foundation models, using certain types of 3D data, such as 3D molecular structure data. Existing approaches for rotationally augmenting 3D molecular structure data have many undesirable limitations, such as: leverage low-level languages like C/C++, which are more difficult to write and maintain than high-level languages, like Python; process only point clouds or voxel data, not both; when applying random rotations, the user is usually unable to: (1) define a rotation axes with a truly random direction, (2) access the exact rotation axis and angle applied to the data, and (3) apply the same discrete random rotation to multiple files per sample (e.g., to input and output images).

One or more embodiments described herein address these and other shortcomings by providing for training robust and generalizable machine learning models, including foundation models by using 3D data, such as 3D molecular structure data. Particularly, such one or more embodiments implement efficient and easy to use 3D rotational augmentation that is capable of rotating different types of data on any axis by any angle. Further, such embodiments can be implemented using a high-level programming language that is easy to maintain and integrate with existing machine learning software, tools, and workflows.

One or more embodiments provides for rotationally augmenting 3D molecular structure data, which offers the capability to rotate both 3D point clouds and voxel data about any axis and by any angle, enhancing the flexibility and applicability of the technique. One or more embodiments implements fast trilinear interpolation to efficiently rotate 3D voxel data, allowing for user-defined values for points that are rotated off-grid. One or more embodiments generates random rotation matrices, avoiding common issues like gimbal lock and singularity, ensuring robust performance. Higher-level programming languages, such as Python, can be used, which provides more functionality than existing packages like high throughput molecular dynamics for molecular discovery (HTMD) without compromising performance, making it easy to maintain and integrate with other software and tools. One or more embodiments addresses rotational equivariance and significantly increases training data size, contributing to the development of deep neural networks and foundation models from relatively small datasets.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

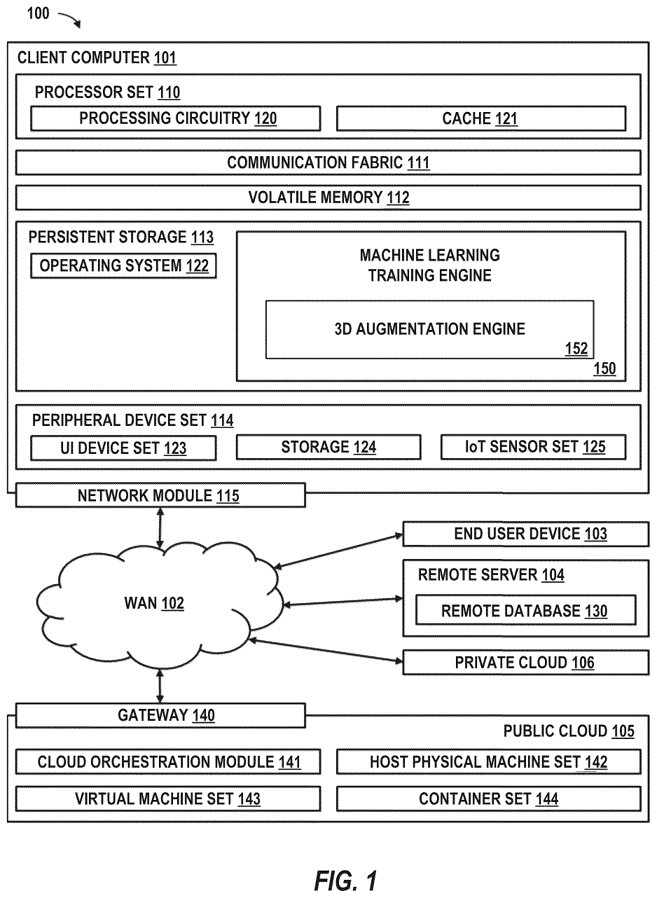

FIG. 1 illustrates a computing environment 100, according to an embodiment. Computing environment 100 contains an example of an environment for the execution of at least some of the computer code involved in performing the inventive methods, such as a machine learning training engine 150 for generating parameters for statistical timing analysis of a circuit. The machine learning training engine 150 can include a 3D augmentation engine 152 for augmenting 3D data used by the machine learning training engine 150, as described further herein. In addition to the machine learning training engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the machine learning training engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the machine learning training engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the machine learning training engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the 3D augmentation engine 152 is responsible for rotationally augmenting 3D data to train a machine learning model. The 3D augmentation engine 152 is now described in more detail with reference to the following figures.

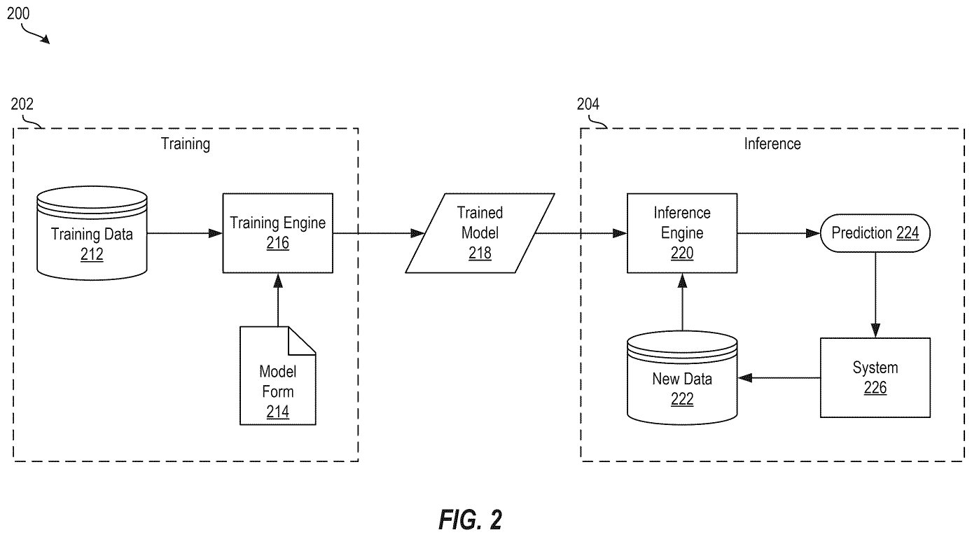

FIG. 2 illustrates a block diagram of components of a machine learning training and inference system 200 according to one or more embodiments described herein.

One or more embodiments described herein can utilize machine learning techniques to perform tasks, such as to make predictions using a machine learning model (e.g., trained model 218) that is trained using rotationally augmented 3D data. More specifically, one or more embodiments described herein can incorporate and utilize rule-based decision making and artificial intelligence (AI) reasoning to accomplish the various operations described herein, namely rotationally augmenting 3D data to train a machine learning model. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for making predictions using a machine learning model that is trained using rotationally augmented 3D data, for example. In one or more embodiments, machine learning functionality can be implemented using an artificial neural network (ANN) having the capability to be trained to perform a function. In machine learning and cognitive science, ANNs are a family of statistical learning models inspired by the biological neural networks in nature. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of making predictions using a machine learning model that is trained using rotationally augmented 3D data as described herein.

Systems for training and using a machine learning model are now described in more detail with reference to FIG. 2. Particularly, FIG. 2 depicts a block diagram of components of a machine learning training and inference system 200 according to one or more embodiments described herein. The system 200 performs training 202 and inference 204. During training 202, a training engine 216 trains a model (e.g., the trained model 218) to perform a task, such as to make predictions. Inference 204 is the process of implementing the trained model 218 to perform the task, such as to make predictions, in the context of a larger system (e.g., a system 226). All or a portion of the system 200 shown in FIG. 2 can be implemented, for example by all or a subset of the computing environment 100 of FIG. 1. For example, the machine learning training engine 150 can be implemented using the training engine 216 of FIG. 2, which is further described herein.

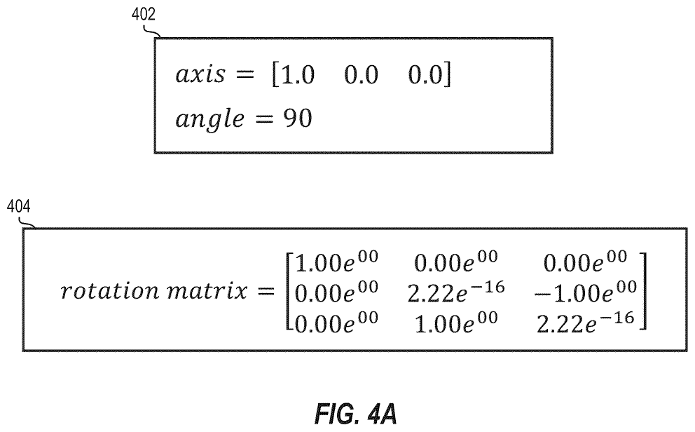

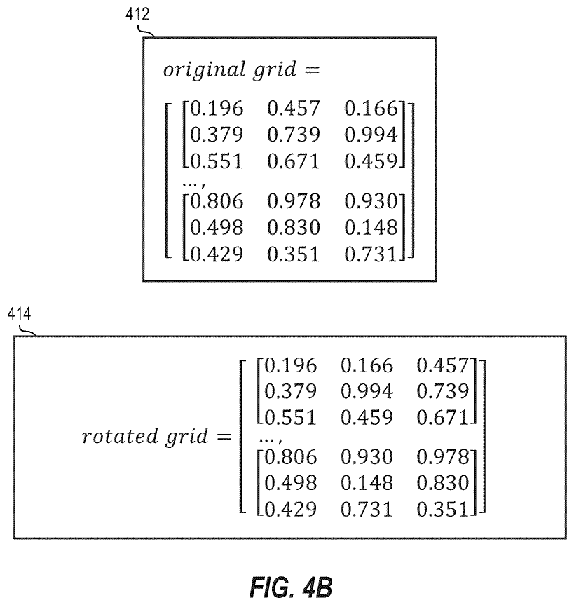

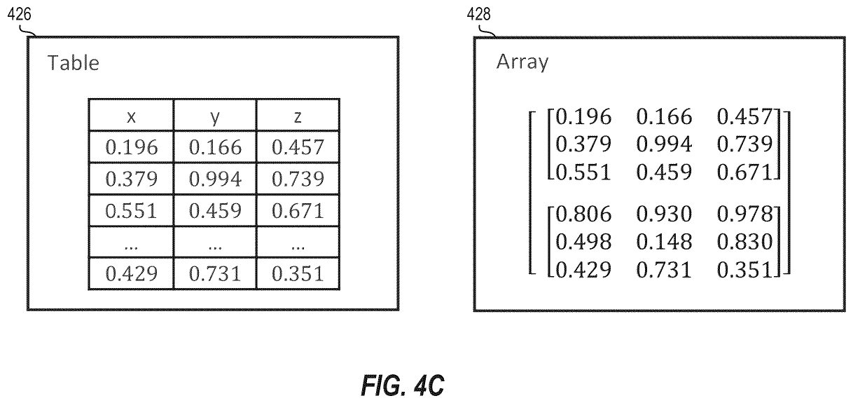

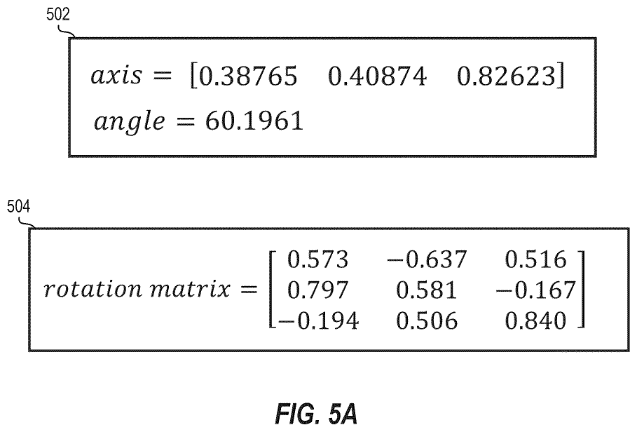

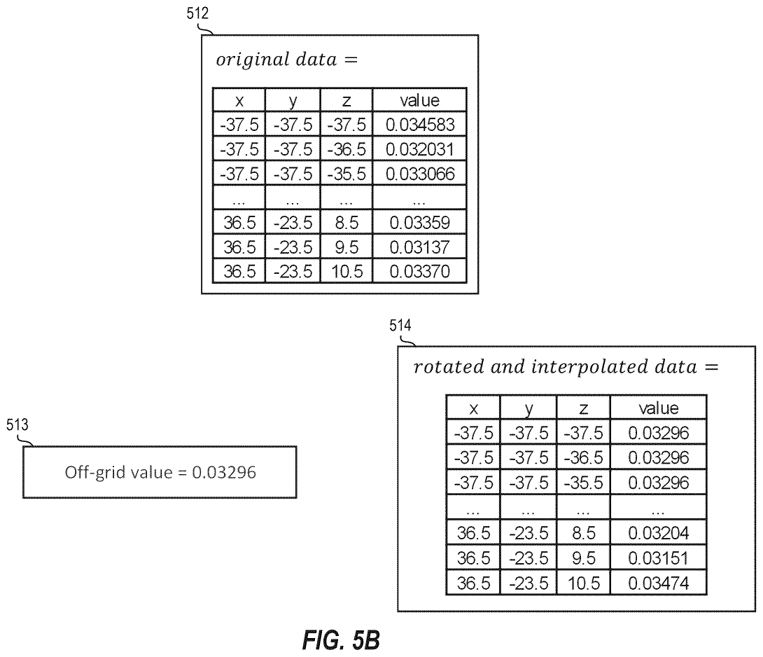

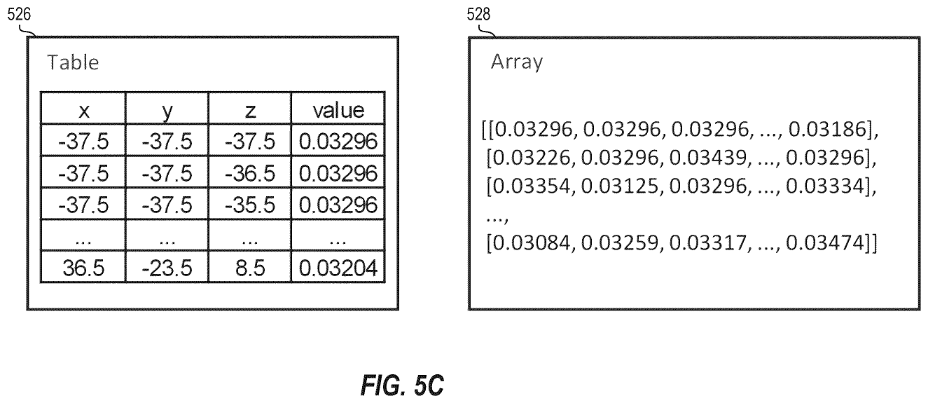

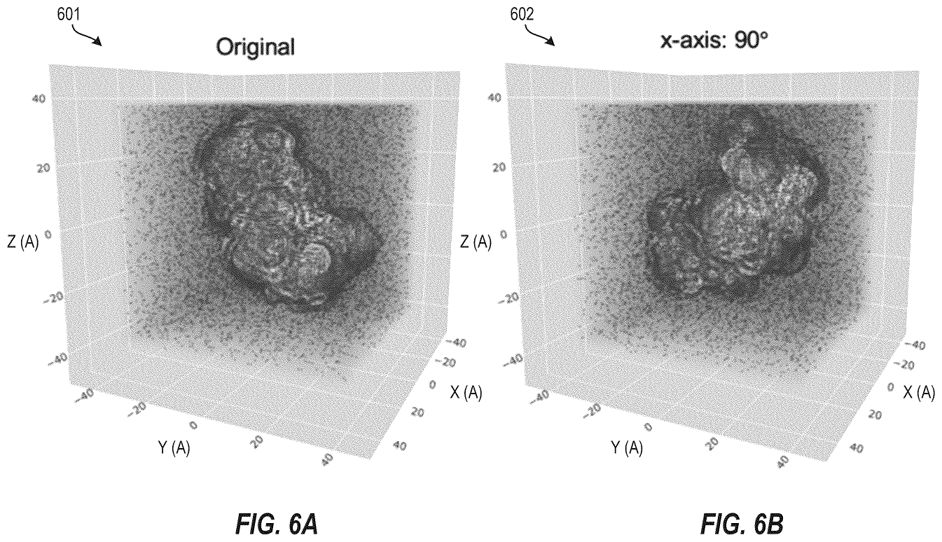

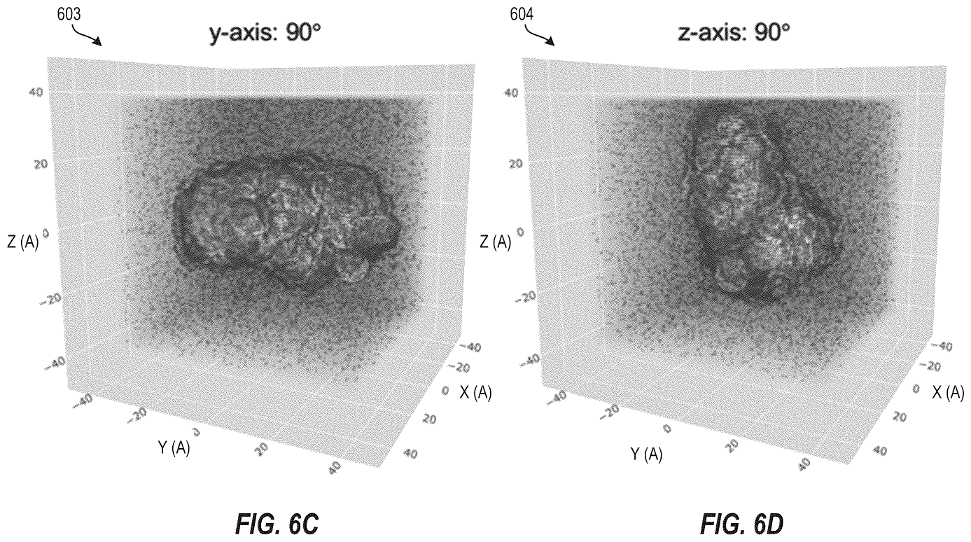

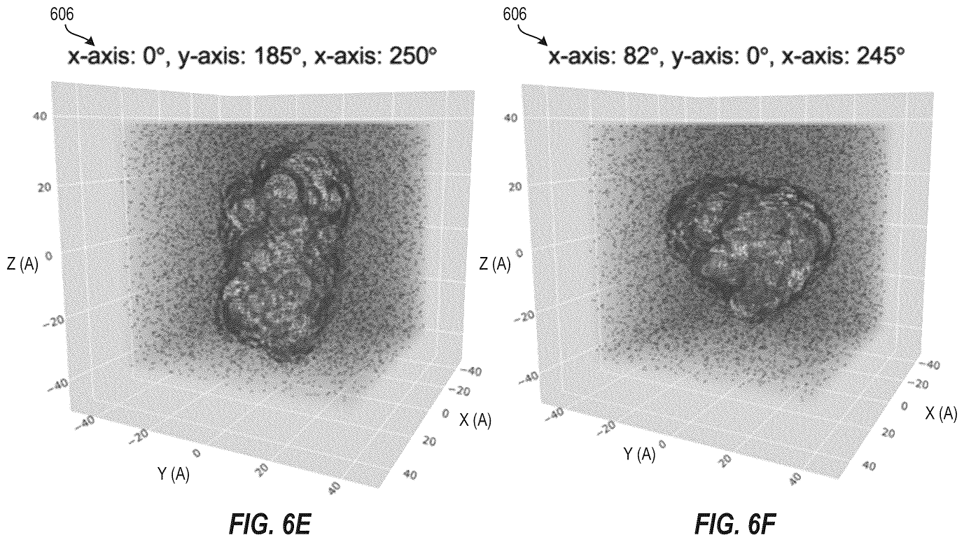

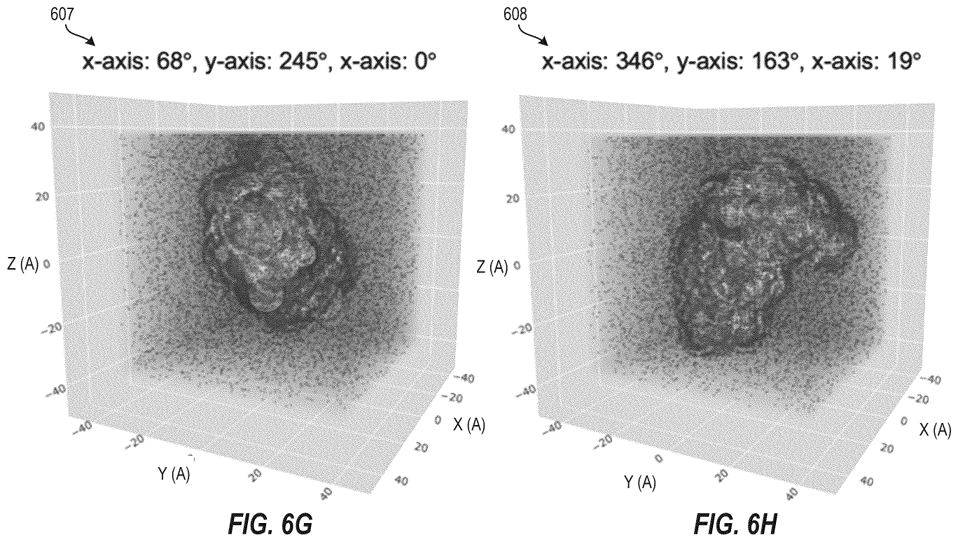

The training 202 begins with training data 212, which may be structured or unstructured data. According to one or more embodiments described herein, the training data 212 includes 3D representations of an object, such as small molecules, compounds, and polymers. According to one or more embodiments, the training data 212 includes one or more of the representations 601-608 shown in FIGS. 6A-6H, which are described in more detail herein. According to one or more embodiments, the training data 212 includes an original coordinate grid (see, e.g., FIG. 4B, FIG. 5B), a rotated coordinate grid (see, e.g., FIG. 4B, FIG. 5B), and/or an interpolated coordinates (see, e.g., FIG. 5C). According to one or more embodiments, the training data 212 includes voxel values.

The training engine 216 (which is an example of the machine learning training engine 150 of FIG. 1) receives the training data 212 and a model form 214. According to one or more embodiments described herein, the model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 may be a model form of a CNN, although other types of model forms and/or algorithms can be implemented.

According to one or more embodiments described herein, the model form 214 represents an algorithm that can be trained to perform a particular task. In some embodiments, the model form 214 is an algorithm that can include, for example, supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms. Examples of supervised learning algorithms can include, for example, averaged one-dependency estimators (AODE); Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

According to one or more embodiments described herein, the model form 214 is a foundation model that is trained on a wide variety of generalized, unlabeled training data to perform one or more different general tasks, such as generating content (text, images, etc.), performing natural language processing, and/or the like including combinations and/or multiples thereof. In the case of the model form 214 being a foundation model, the training 202 can include tuning the foundation model (e.g., the model form 214) using the training data 212. Tuning the foundation model provides the benefits of the broad capabilities of the foundation model while enabling the foundation model to be customized using training data (e.g., the training data 212) related to a particular task or environment to which the foundation modal is then applied. In this way, the training 202 need not train a new model from scratch, which is time consuming and resource intensive.

The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 may be performed multiple times (referred to as “epochs”) until a suitable model is trained (e.g., the trained model 218).

Once trained, the trained model 218 can be used to perform inference 204 to perform a task, such as to perform a prediction or generate new data. The inference engine 220 applies the trained model 218 to new data 222 (e.g., real-world, non-training data). For example, if the trained model 218 is trained to classify images of a particular object, such as a molecule, the new data 222 can be an image of a molecule that was not part of the training data 212. In this way, the new data 222 represents data to which the trained model 218 has not been exposed. The inference engine 220 makes a prediction 224 (e.g., a prediction of a molecule in an image of the new data 222) and passes the prediction 224 to the system 226 (e.g., the computing environment 100 of FIG. 1). The system 226 can, based on the prediction 224, taken an action, perform an operation, perform an analysis, and/or the like, including combinations and/or multiples thereof. In some embodiments, the system 226 can add to and/or modify the new data 222 based on the prediction 224.

In accordance with one or more embodiments, the predictions 224 generated by the inference engine 220 are periodically monitored and verified to ensure that the inference engine 220 is operating as expected. Based on the verification, additional training 202 may occur using the trained model 218 as the starting point. The additional training 202 may include all or a subset of the original training data 212 and/or new training data 212. In accordance with one or more embodiments, the training 202 includes updating the trained model 218 to account for changes in expected input data.

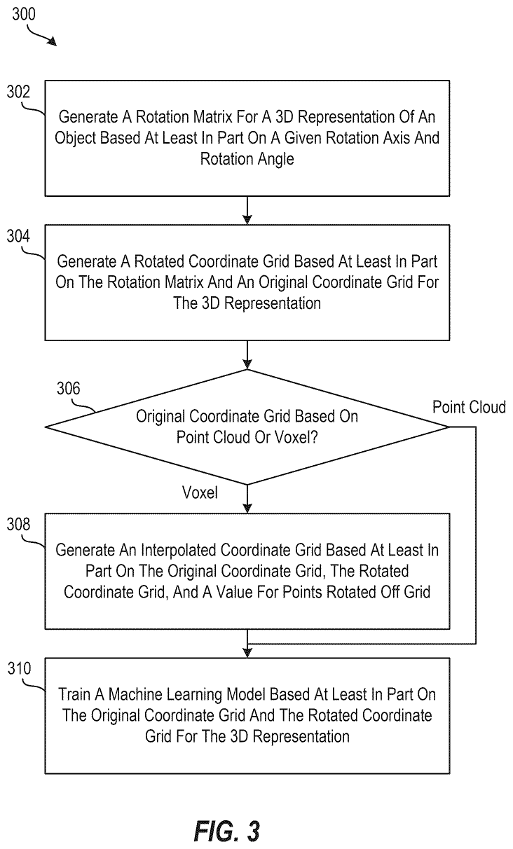

FIG. 3 illustrates a flow diagram of a method 300 for training a machine learning model (e.g., trained model 218) according to one or more embodiments described herein. The method 300 can be performed by any suitable computing system, device, or environment, such as those described herein. The method 300 is now described with reference to the computing environment 100, and particularly the machine learning training engine 150 and the 3D augmentation engine 152, but is not so limited. That is, the method 300 depicts operations performed by the 3D augmentation engine 152 to rotationally augment 3D data to train a machine learning model.

It should be appreciated that the method 300 can be applied to 3D data represented as a point cloud corresponding to point cloud data or as voxels corresponding to voxel data. This enables the method 300 to be applied to different types of molecular and materials science data including small molecules, compounds, and polymers from a wide range of sources including point cloud databases (e.g., the Protein Data Bank) and output from molecular dynamics simulations.

The method 300 addresses rotational equivariance, yielding more generalizable machine learning models by reducing overfitting and meaningfully increasing the size of training data, which facilitates the development of deep neural networks and foundation models from relatively smaller data sets that existing approaches require.

The method 300 is now described in more detail with reference to FIGS. 4A, 4B, and 4C, which relate to an example of rotational augmentation without interpolation, and to FIGS. 5A, 5B, and 5C, which relate to an example of rotational augmentation with interpolation. In particular, FIG. 4A illustrates a given rotation axis and rotation angle 402 and a rotation matrix 404 according to one or more embodiments described herein. FIG. 4B illustrates an original coordinate grid 412 and a rotated coordinate grid 414 according to one or more embodiments described herein. FIG. 4C illustrates a table 426 and an array 428 according to one or more embodiments described herein. FIG. 5A illustrates a given rotation axis and rotation angle 502 and a rotation matrix 504 according to one or more embodiments. FIG. 5B illustrates an original coordinate grid 512, an off-grid value 513, and a rotated coordinate grid with interpolation 514 according to one or more embodiments described herein. FIG. 5C illustrates a table 526 and an array 528 according to one or more embodiments described herein.

With reference to FIG. 3, the method 300 begins at operation 302, where a rotation matrix (e.g., rotation matrix 404, rotation matrix 504) is generated for a 3D representation of an object, such as a 3D molecular structure. The generation of the rotation matrix is based on a given rotation axis and angle (e.g., given rotation axis and rotation angle 402, given rotation axis and rotation angle 502), which may be specified by a user or randomly generated. According to one or more embodiments, generating the rotation matrix is performed using Euler-Rodrigues parameters. Euler-Rodrigues parameters are a mathematical representation used to describe the orientation of a rigid body in 3D space. Euler-Rodrigues parameters are useful for representing rotations because they provide a compact and efficient way to encode rotational transformations without the singularities and ambiguities associated with other methods, such as Euler angles. By using Euler-Rodrigues parameters, one can generate rotation matrices that are free from issues like gimbal lock, which can occur with Euler angles.

For example, with reference to FIG. 4A, the given rotation axis and rotation angle 402 defines the parameters used to define the rotation, which includes the rotation axis and the rotation angle. In this instance, the rotation axis is represented as a vector [1.0, 0.0, 0.0], indicating a rotation about the x-axis (without rotation about the y-axis or z-axis), and the rotation angle is set at 90 degrees. It should be appreciated that other rotation axis and rotation angles can be used in other embodiments, and that the example shown in FIG. 4A should not be considered limiting. In this example, the rotation matrix 404 is a 3×3 matrix derived from the given rotation axis and angle 402. The rotation matrix 404 is used to transform the coordinates of the 3D representation, effectively rotating it about the specified axis by the given angle. The values in the matrix reflect the mathematical calculations involved in this transformation, ensuring that the rotation is accurately applied to the data.

As another example, with reference to FIG. 5A, the given rotation axis and rotation angle 502 defines the parameters used to define the rotation, which includes the rotation axis and the rotation angle. In this instance, the rotation axis is represented as a vector [0.38765, 0.40874, 0.82623], indicating a rotation about the x-, y-, and z-axes, and the rotation angle is set at 60.1961 degrees. It should be appreciated that other rotation axis and rotation angles can be used in other embodiments, and that the example shown in FIG. 5A should not be considered limiting. In this example, the rotation matrix 504 is a 3×3 matrix derived from the given rotation axis and angle 502. The rotation matrix 504 is used to transform the coordinates of the 3D representation, effectively rotating it about the specified axes by the given angle. The values in the matrix reflect the mathematical calculations involved in this transformation, ensuring that the rotation is accurately applied to the data.

With continued reference to FIG. 3, operation 304 involves generating a rotated coordinate grid (e.g., rotated coordinate grid 414, rotated coordinate grid 514) using the rotation matrix (e.g., rotation matrix 404, rotation matrix 504) and the original coordinate grid of the 3D representation (e.g., original coordinate grid 412, original coordinate grid 512). Operation 304 rotates the original coordinate grid without associated values from point cloud data and the original coordinate grid with associated values inferred from 3D voxels of 3D voxel data.

For example, with reference to FIG. 4B, the original coordinate grid 412 is depicted as a matrix of coordinate values, representing the initial spatial configuration of the 3D data for the object. The original coordinate grid 412 includes several rows of numerical values, each corresponding to a specific point in 3D space. The values in the original coordinate grid 412 are arranged in a specific order, reflecting the original orientation of the data, where each row represents a point, and each column represents a value for an x-axis value, y-axis value, and z-axis value relative to an origin point for the point of the row. That is, the first row of the original coordinate grid 412 indicates a first point located at [0.196, 0.166, 0.457], the second row of the original coordinate grid 412 indicates a second point located at [0.379, 0.994, 0.739], and so forth. The rotated coordinate grid 414 shows the result of applying the rotation matrix 404 to the original coordinate grid 412. The transformation repositions the coordinate values for each of the points or voxels of the 3D data, altering their arrangement to reflect the new orientation of the 3D data. In this example, where the 3D data is rotated 90 degrees about the x-axis, the rotated coordinate grid 414 maintains the same numerical values as the original coordinate grid 412 but in a different order, demonstrating how the rotation affects the spatial configuration of the data. It should be appreciated that other rotations are possible.

As another example, with reference to FIG. 5B, the original coordinate grid 512 is depicted as a matrix of coordinate values, representing the initial spatial configuration of the 3D data for the object, which in this case is voxel data. The original coordinate grid 512 includes several rows of numerical values, each corresponding to a specific point in 3D space. The values in the original coordinate grid 512 are arranged in a specific order, reflecting the original orientation of the data, where each row represents a point, and each column represents a value for an x-axis value, y-axis value, and z-axis value relative to an origin point for the point of the row, along with a corresponding value for each voxel. That is, the first row of the original coordinate grid 512 indicates a first point located at [−37.5, −37.5, −37.5] and having a value of 0.034583, the second row of the original coordinate grid 512 indicates a second point located at [−37.5, −37.5, −36.5] and having a value of 0.032031, and so forth. The rotated coordinate grid 514 shows the result of applying the rotation matrix 504 (with interpolation) to the original coordinate grid 512. The transformation repositions the coordinate values for each of the voxels of the 3D data, altering their arrangement to reflect the new orientation of the 3D data.

With continued reference to FIG. 3, at operation 306, the method 300 determines whether the original coordinate grid 412 is based on point cloud data or voxel data. If the data is identified as voxel-based, the method 300 proceeds to operation 308, where interpolated coordinates are generated and represented, such as using a table or an array. This interpolation is based on the original coordinate grid 512, the rotated coordinate grid 514, and a specified value for points that are rotated off-grid (e.g., off-grid value 513).

For example, FIG. 5C illustrates the process of handling and representing interpolated grid values during the rotational augmentation with interpolation of 3D voxel data. The off-grid value 513, which is set to 0.03296 in this example, is used to fill in areas where data points (e.g., voxels) fall outside the boundaries of the original coordinate grid after rotation. The off-grid value 513 can be set to any user provided value for points rotated off-grid. That is, some points may fall outside the boundaries of the original coordinate grid 512 due to the rotation. These points can be adjusted using the off-grid value 513. The interpolated grid values, shown in table 526 and array 528 of FIG. 5C, result from applying an interpolation technique (e.g., trilinear interpolation) to translate the value of the original coordinate grid 512 to their new positions in the rotated coordinate grid 514. Trilinear interpolation is an approached used to estimate values within a 3D space, particularly when dealing with voxel data. Trilinear interpolation extends the concept of linear interpolation, which is used in one-dimensional spaces, and bilinear interpolation, which is used in two-dimensional spaces, to three dimensions. According to one or more embodiments, in trilinear interpolation, the value at a given point within a 3D grid is determined by considering the values at the eight surrounding grid points (forming a cube) and interpolating these values based on the relative position of the point within the cube. According to one or more embodiments, trilinear interpolation can be applied to orthorhombic (non-cubic) voxels. This approach is useful for smoothly transitioning between discrete data points in a 3D grid, such as when rotating or transforming voxel data, ensuring that the resulting interpolated values maintain continuity and accuracy.

The interpolated grid values, shown in table 526 and array 528 of FIG. 5C, can applied to the rotated coordinate grid 514 to generate interpolated coordinates, which can be expressed in various forms, such as in a tabular format (e.g., table 526) and an array format (e.g., array 528). The table 526 provides a clear and organized view of how the original data points have been transformed and interpolated, with columns for the x, y, and z coordinates, as well as the corresponding voxel value for each point. The array 528 is commonly used in computational processes, allowing for efficient data manipulation and analysis.

With continued reference to FIG. 3, after operation 308 is completed for voxel data, or responsive to data being identified as pixel-based (operation 306), the method 300 proceeds to operation 310. At operation 310, the machine learning model is trained using both the original coordinate grid 412 and the rotated coordinate grid 414 for the point cloud-based 3D representation or using both the original coordinate grid 512 and the rotated coordinate grid 514 for the voxel-based 3D representation.

This comprehensive approach ensures that the resulting trained machine learning model can generalize across different spatial orientations and can apply to point cloud data or voxel data, enhancing its predictive capabilities. The method 300 effectively outlines the operations involved in augmenting the original data through rotational transformations, thereby improving the model's robustness, generalizability, and accuracy.

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

FIG. 6A-6H illustrate 3D representations 601-608, respectively, used to train a machine learning model according to one or more embodiments described herein. As is further described herein, FIG. 6A depicts a 3D representation 601 that is considered an original (e.g., un-rotated/un-augmented) representation of 3D data, and FIGS. 6B-6H depict multiple augmented 3D representations (e.g., 3D representations 602-608) based on the original representation after one or more embodiments described herein are applied to the original representation.

The 3D representation 601 of FIG. 6A depicts the original 3D molecular structure data, represented as a dense point cloud within a coordinate grid. This visualization serves as the baseline for understanding how the 3D data appears before any rotational transformations are applied. The structure is shown in its initial orientation, providing a reference for subsequent figures (e.g., FIGS. 6B-6H) that demonstrate various rotations, which are described in more detail herein. The axes are labeled X, Y, and Z, with units in angstroms (A), and the data points are distributed throughout the 3D space as shown, highlighting the complexity and density of the molecular structure.

The 3D representation 602 of FIG. 6B illustrates the same 3D molecular structure data of FIG. 6A after a 90-degree rotation is applied about the x-axis. This transformation reorients the data, allowing for a different perspective of the molecular structure. The rotation about the x-axis shifts the distribution of points as shown, providing insights into the structure's spatial configuration from a new angle. FIG. 6B demonstrates the effect of a single-axis rotation, emphasizing how the orientation of the data can be altered while maintaining its overall integrity.

The 3D representation 603 of FIG. 6C shows the 3D molecular structure data after a 90-degree rotation about the y-axis. This rotation provides another perspective, distinct from the x-axis rotation shown in FIG. 6B. By rotating about the y-axis, the data points are repositioned, offering a different view of the molecular structure's spatial arrangement. FIG. 6C highlights the versatility of the rotational augmentation method, showcasing how different single-axis rotations can reveal various aspects of the data.

The 3D representation 604 of FIG. 6D shows the 3D molecular structure data following a 90-degree rotation about the z-axis. This transformation further exemplifies the ability of one or more embodiments to alter the 3D data's orientation, providing yet another unique perspective. The rotation about the z-axis shifts the data points in a manner distinct from the x and y-axis rotations shown in FIGS. 6B and 6C, respectively, illustrating the comprehensive nature of the rotational augmentation process. FIG. 6D completes the series of single-axis rotations, demonstrating the capability of one or more embodiments to explore the structure from multiple angles.

The 3D representation 605 of FIG. 6E demonstrates a more complex rotation involving multiple axes, with the 3D data rotated by 0 degrees about the x-axis, 185 degrees about the y-axis, and 250 degrees about the z-axis. This multi-axis rotation significantly alters the 3D data's orientation as compared to its original orientation shown in FIG. 5A, offering a comprehensive view of the molecular structure from a new vantage point. The combination of rotations about different axes showcases the flexibility of one or more embodiments in achieving complex transformations, allowing for a thorough exploration of the 3D data's spatial characteristics.

The 3D representation 606 of FIG. 6F illustrates another multi-axis rotation, with the data rotated by 82 degrees about the x-axis, 0 degrees about the y-axis, and 245 degrees about the z-axis. This figure highlights the ability of one or more embodiments to apply distinct rotational angles to multiple axes, resulting in a unique orientation of the molecular structure relative to its original orientation shown in FIG. 5A. The transformation provides additional insights into the 3D data's spatial configuration, emphasizing the capability to achieve diverse and intricate rotations.

The 3D representation 607 of FIG. 6G features a rotation with angles of 68 degrees about the x-axis, 245 degrees about the y-axis, and 0 degrees about the z-axis. This figure further demonstrates the versatility of one or more embodiments in applying complex rotational transformations. The resulting orientation offers a different perspective on the molecular structure relative to its original orientation shown in FIG. 5A, showcasing the ability of one or more embodiments to reveal various aspects of the data through strategic rotations. This figure underscores the potential for enhancing the understanding of 3D molecular structures.

The 3D representation 608 of FIG. 6H presents a multi-axis rotation where rotation is applied to each of the three axes. More particularly, the 3D representation 608 shows the 3D data rotated by 346 degrees about the x-axis, 163 degrees about the y-axis, and 19 degrees about the z-axis. This transformation exemplifies the capacity of one or more embodiments to apply a wide range of rotational angles, resulting in a distinct orientation of the molecular structure relative to its original orientation shown in FIG. 6A. FIG. 6H highlights the effectiveness of one or more embodiments in exploring the 3D data's spatial characteristics from multiple perspectives, demonstrating the utility in augmenting training datasets for machine learning models.

The representations 602-608 of FIGS. 6B-6H, respectively, demonstrate seven unique rotationally augmented representations generated from an original 3D voxelized representation (e.g., the representation 601 of FIG. 6A). The representations 602-604 of FIGS. 6B-6D represent three one-axis rotations, the representations 606-607 of FIGS. 6E-6G represent three two-axis rotations, and the representation 608 of FIG. 6H represents a three-axis rotation. It should be appreciated that the representations 601-608 are merely examples, and that other examples are possible in various embodiments. For example, different rotation angles and rotation axes can be used in other embodiments to generate multiple augmented representations (the representation 602-608) from the original representation (e.g., the representation 601). The capability to rotate data around any desired axis by any desired angle makes it easy for users to define rotation axes with truly random directions and as well as to apply the same random rotation or sets of random rotations to multiple files per sample.

One or more embodiments described herein significantly enhance the training of machine learning models by providing a robust approach to rotationally augmenting 3D data used for training machine learning models. This approach provides for the rotation of 3D data (which can be point cloud data or voxel data) about any axis and by any angle, thereby increasing the diversity and size of training datasets used for training machine learning models. By implementing trilinear interpolation, one or more embodiments ensures that voxel data is accurately transformed, maintaining data integrity and continuity. This augmentation process helps machine learning models generalize better across different spatial orientations, reducing overfitting and improving predictive accuracy, while requiring relatively less data to train.

One or more embodiments provide for improving the operation/functionality of computing systems. For example, one or more embodiments can be implemented using higher-level programming languages, such as Python, that are easy to maintain and integrate with existing machine learning frameworks. This choice enhances computer functionality by providing a more accessible and efficient way to perform complex data transformations, avoiding the complications of low-level languages like C/C++. Moreover, the use of Euler-Rodrigues parameters for generating rotation matrices ensures that the computing system avoids issues like gimbal lock, leading to more stable and reliable computations while avoiding wasted computational operations due to issues like gimbal lock.

One or more embodiments, such as the method 300 of FIG. 3, performs rotation matrix generation (operation 302) and data rotation (operation 304) substantially 60%-81% faster and interpolation (operation 308) substantially 45% faster than existing approaches for data sets containing up to 1 million rows.

Overall, these technical improvements contribute to the development of deep neural networks and foundation models from relatively small datasets, addressing market demand for more efficient and effective machine learning solutions. The ability of one or more embodiments to quickly and meaningfully increase training data size, while maintaining computational efficiency, represents a significant advancement in the field of machine learning and data processing, particularly relating to 3D data.

While the foregoing is directed to embodiments of the present disclosure, other and further embodiments of the present disclosure may be devised without departing from the basic scope thereof, and the scope thereof is determined by the claims that follow.

What is claimed is:

1. A method comprising:
generating a rotation matrix for a three-dimensional (3D) representation of an object based at least in part on a given rotation axis and rotation angle;
generating a rotated coordinate grid based at least in part on the rotation matrix and an original coordinate grid for the 3D representation; and
training a machine learning model based at least in part on the original coordinate grid and the rotated coordinate grid for the 3D representation.

2. The method of claim 1, further comprising determining whether the original coordinate grid is based on point cloud data or voxel data.

3. The method of claim 2, wherein training the machine learning model is performed responsive to determining that the original coordinate grid is based on point cloud data.

4. The method of claim 2, further comprising, responsive to determining that the original coordinate grid is based on voxel data, generating interpolated coordinates based at least in part on the original coordinate grid, the rotated coordinate grid, and a value for points rotated off-grid.

5. The method of claim 4, wherein the training is further based at least in part on the interpolated coordinates.

6. The method of claim 1, wherein the object is a molecular structure, and wherein the 3D representation is a 3D representation of the molecular structure.

7. The method of claim 1, wherein generating the rotation matrix is performed using Euler-Rodrigues parameters.

8. The method of claim 1, wherein generating the rotated coordinate grid is performed using trilinear interpolation.

9. A computer system comprising:
a processor set;
one or more computer-readable storage media; and
program instructions stored on the one or more computer-readable storage media to cause the processor set to perform operations, the operations comprising:
generating a rotation matrix for a three-dimensional (3D) representation of an object based at least in part on a given rotation axis and rotation angle;
generating a rotated coordinate grid based at least in part on the rotation matrix and an original coordinate grid for the 3D representation; and
training a machine learning model based at least in part on the original coordinate grid and the rotated coordinate grid for the 3D representation.

10. The computer system of claim 9, wherein the operations further comprise determining whether the original coordinate grid is based on point cloud data or voxel data.

11. The computer system of claim 10, wherein training the machine learning model is performed responsive to determining that the original coordinate grid is based on point cloud data.

12. The computer system of claim 10, wherein the operations further comprise, responsive to determining that the original coordinate grid is based on voxel data, generating interpolated coordinates based at least in part on the original coordinate grid, the rotated coordinate grid, and a value for points rotated off-grid.

13. The computer system of claim 12, wherein the training is further based at least in part on the interpolated coordinates.

14. The computer system of claim 9, wherein the object is a molecular structure, and wherein the 3D representation is a 3D representation of the molecular structure.

15. The computer system of claim 9, wherein generating the rotation matrix is performed using Euler-Rodrigues parameters.

16. The computer system of claim 9, wherein generating the rotated coordinate grid is performed using trilinear interpolation.

17. A computer program product comprising:
one or more computer-readable storage media; and
program instructions stored on the one or more computer-readable storage media to perform operations comprising:
generating a rotation matrix for a three-dimensional (3D) representation of an object based at least in part on a given rotation axis and rotation angle;
generating a rotated coordinate grid based at least in part on the rotation matrix and an original coordinate grid for the 3D representation; and
training a machine learning model based at least in part on the original coordinate grid and the rotated coordinate grid for the 3D representation.

18. The computer program product of claim 17, wherein the operations further comprise determining whether the original coordinate grid is based on point cloud data or voxel data.

19. The computer program product of claim 18, wherein training the machine learning model is performed responsive to determining that the original coordinate grid is based on point cloud data.

20. The computer program product of claim 18, wherein the operations further comprise, responsive to determining that the original coordinate grid is based on voxel data, generating interpolated coordinates based at least in part on the original coordinate grid, the rotated coordinate grid, and a value for points rotated off-grid.
